(19) United States
(12) Patent Application Publication
(10) Pub. No.: US 2015/0153925 A1
(43) Pub. Date: Jun. 4, 2015

(54) METHOD FOR OPERATING GESTURES AND METHOD FOR CALLING CURSOR

(71) Applicant: Acer Incorporated, New Taipei City (TW)

(72) Inventors: Chien-Hung Li, New Taipei City (TW); Yin-Hsong Hsu, New Taipei City (TW); Yu-Hsuan Shen, New Taipei City (TW); Yueh-Yarng Tsai, New Taipei City (TW)

(73) Assignee: Acer Incorporated, New Taipei City (TW)

(21) Appl. No.: 14/267,911

(22) Filed: May 2, 2014

(30) Foreign Application Priority Data
Nov. 29, 2013 (TW) 102143626

(51) Int. Cl. G06F 3/0488; G06F 3/0481; G06F 3/0482

(52) U.S. Cl. CPC G06F 3/0488; G06F 3/0482; G06F 3/04812

(57) ABSTRACT

A method for operating gestures and a method for calling a cursor adapted to an electronic device having a touch area are provided. The method for calling the cursor is as follows. A first gesture input to the touch area by an operating object is received. It is detected whether a second gesture is continuously input by the operating object from an end point of the first gesture after the first gesture is input. When the second gesture is not continuously input by the operating object from the end point and the operating object leaves the touch area, a first operation is executed. When the second gesture is continuously input by the operating object and the operating object does not leave the touch area, a cursor is called and the cursor is moved to a location where the operating object contacts the touch area.

### CROSS-REFERENCE TO RELATED APPLICATION

This application claims the priority benefit of Taiwan application serial no. 102143626, filed on Nov. 29, 2013. The entirety of the above-mentioned patent application is hereby incorporated by reference herein and made a part of this specification.

### BACKGROUND

1. Technical Field

The invention relates to a control technique of an electronic device. Particularly, the invention relates to a method for operating gestures and a method for calling a cursor.

2. Related Art

To facilitate operation, present consumer electronic devices are generally configured with a touch screen or a touch pad to facilitate a user controlling the electronic device or performing information input. When a screen resolution of the electronic device is relatively high, icons in a user interface are excessively small, and the user is hard to click the icon by using a finger which is larger than the icons in size. Therefore, some manufacturers suggest a method of “touch cursor”, by which a touch cursor capable of assisting the user to select an object is provided in the user interface, where the touch cursor can be easily moved by the user, and a front end thereof can easily select the icon required by the user.

However, if the touch screen of the electronic device is relatively large, the user is required to perform a long-distance dragging operation on the touch cursor. In this way, each time when the user needs to move the touch cursor, the user's finger has to contact the touch panel for a long time. When a contact time between the finger and the touch panel is excessively long due to a longer moving distance, the user's finger is uncomfortable due to friction between the touch panel and the finger. Therefore, the user is probably tired of using the touch cursor and gradually does not want to use such function.

Moreover, the electronic device having the touch screen is seldom capable of recognizing a continuous gesture input. For example, the existing electronic device can only perform recognition and execute a corresponding operation immediately after receiving a first gesture input by the user, and cannot wait for the user to finish inputting continuous gestures and respectively recognize the gestures. In this way, when the manufacture designs related gesture operations, more convenient and diversified functions cannot be developed.

### SUMMARY

The invention is directed to a method for operating gestures, which is capable of providing diversified gesture operations.

The invention is directed to a method for calling a cursor, by which a user is capable of easily calling and moving a touch cursor, and steps for moving the touch cursor are simplified to improve convenience for using the touch cursor.

The invention provides a method for operating gestures, which is adapted to an electronic device having a touch area. The method for operating gestures includes following steps. A first gesture input to the touch area by an operating object is received. After the first gesture is input, it is detected whether a second gesture is continuously input by the operating object from an end point of the first gesture. When the second gesture is continuously input by the operating object from the end point, a second operation corresponding to the first gesture and the second gesture is executed.

In an embodiment of the invention, the method for operating gestures further includes following steps. When the second gesture is not continuously input by the operating object from the end point and the operating object leaves the touch area, a first operation corresponding to the first gesture is executed.

In an embodiment of the invention, the first gesture refers to that the operating object presses a first position of the touch area by a predetermined time. The second gesture refers to that the operating object moves from the first position of the touch area to other positions.

In an embodiment of the invention, the first operation is to display a menu. The second operation is to move a touch cursor to a position where the operating object contacts the touch area.

In an embodiment of the invention, the method for operating gestures further includes following steps. When the operating object is located at the end point and does not leave the touch area, a prompt operation corresponding to the second operation is executed.

In an embodiment of the invention, the prompt operation is to display a translucent cursor at the end point.

According to another aspect, the invention provides a method for calling a cursor, which is adapted to an electronic device having a touch area. The method for calling the cursor includes following steps. A first gesture input to the touch area by an operating object is received. After the first gesture is input, it is detected whether a second gesture is continuously input by the operating object from an end point of the first gesture. When the second gesture is not continuously input by the operating object from the end point and the operating object leaves the touch area, an operation corresponding to the first gesture is executed. When the operating object does not leave the touch area and the second gesture is continuously input from the end point, a cursor is called and the cursor is moved to a position where the operating object contacts the touch area.

Referring the aforementioned descriptions for other implementation details of the method for calling the cursor, and details thereof are not repeated.

According to the above description, the method for operating gestures of the invention is capable of detecting whether the input gesture is continuous, and executing the corresponding operation according to whether the input gesture is continuous, so as to facilitate providing diversified gesture functions. On the other hand, according to the method for calling the cursor of the invention, the user can easily use a commonly used gesture combination to call and move the touch cursor, such that steps for moving the touch cursor are simplified to improve convenience for using the touch cursor.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic device 100 according to an embodiment of the invention.

FIG. 2 is a flowchart illustrating a method for operating gestures/method for calling a cursor according to a first embodiment of the invention.

FIG. 3A-FIG. 3D are schematic diagrams of a method for operating gestures/method for calling a cursor according to the first embodiment of the invention.

### DETAILED DESCRIPTION OF DISCLOSED EMBODIMENTS

In a consumer electronic device having a touch screen, to facilitate manufactures providing diversified functions when designing related gesture operations, the invention provides a method for operating gestures capable of detecting whether gestures are continuously input, and “calling of a touch cursor” is taken as an example. In another embodiment of the invention, “function calling of drawing software” is taken as another example to facilitate conveying the spirit of the invention to those skilled in the art. The invention is not limited to the embodiments in the following descriptions, but provides a gesture operating technique that can be suitably applied to related electronic devices for those skilled in the art.

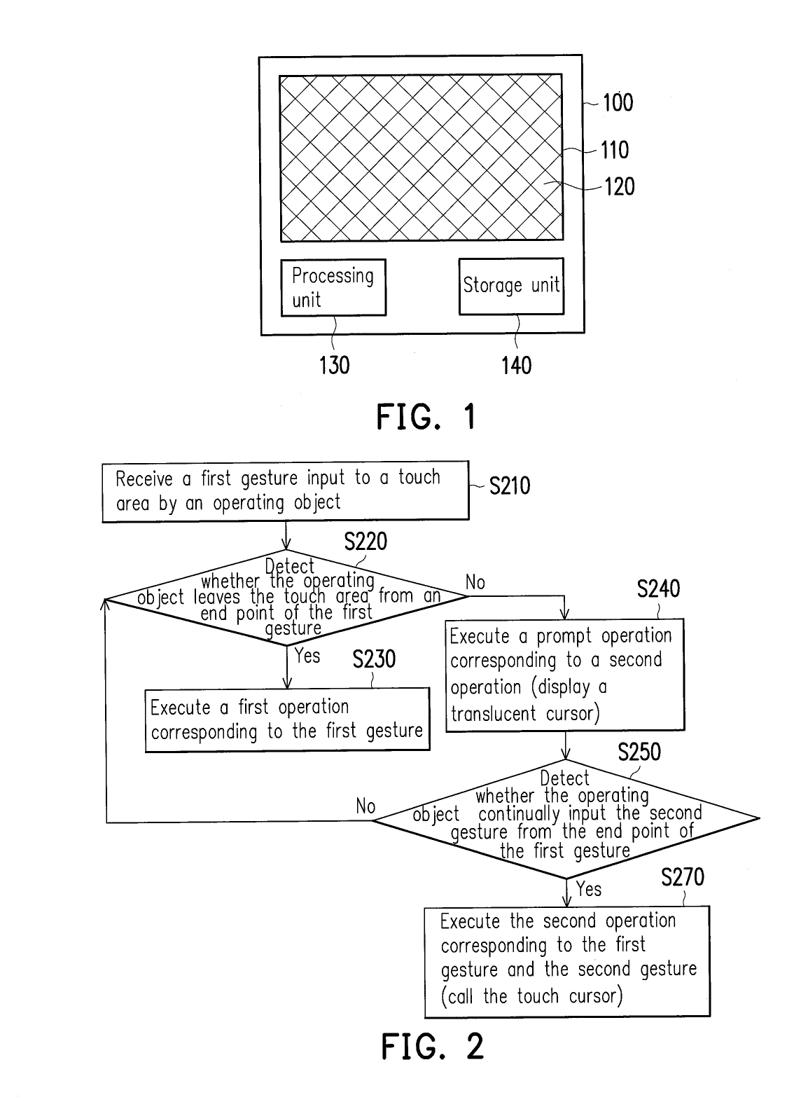

Referring to FIG. 1, FIG. 1 is a block diagram of an electronic device 100 according to an embodiment of the invention. The electronic device 100 can be a related consumer electronic device having a touch area 120, for example, a smart phone, a tablet personal computer (PC), a notebook computer having a touch pad, etc. The electronic device 100 of the present embodiment includes a touch screen 110 having the touch area 120, which is capable of receiving gesture information input by the user through an operating object (for example, user's finger, stylus, etc.). The touch screen 110 can be a capacitive touch panel, a resistive touch panel or an optical mask touch panel. Besides the touch screen 110, the electronic device 100 further includes a processing unit 130 and a storage unit 140. In other embodiments, the electronic device 100 may also have a touch panel having the touch area 120 for receiving the gesture information.

Besides the touch screen 110, the electronic device 100 of the present embodiment further includes the processing unit 130 and the storage unit 140. The processing unit 130 can be a central processing unit (CPU) of the electronic device 100. The storage unit 140 can be an information storage device such as a hard drive, a flash memory, a dynamic random access memory (DRAM), etc., which is used for implementing a following method for operating gestures/method for calling a cursor.

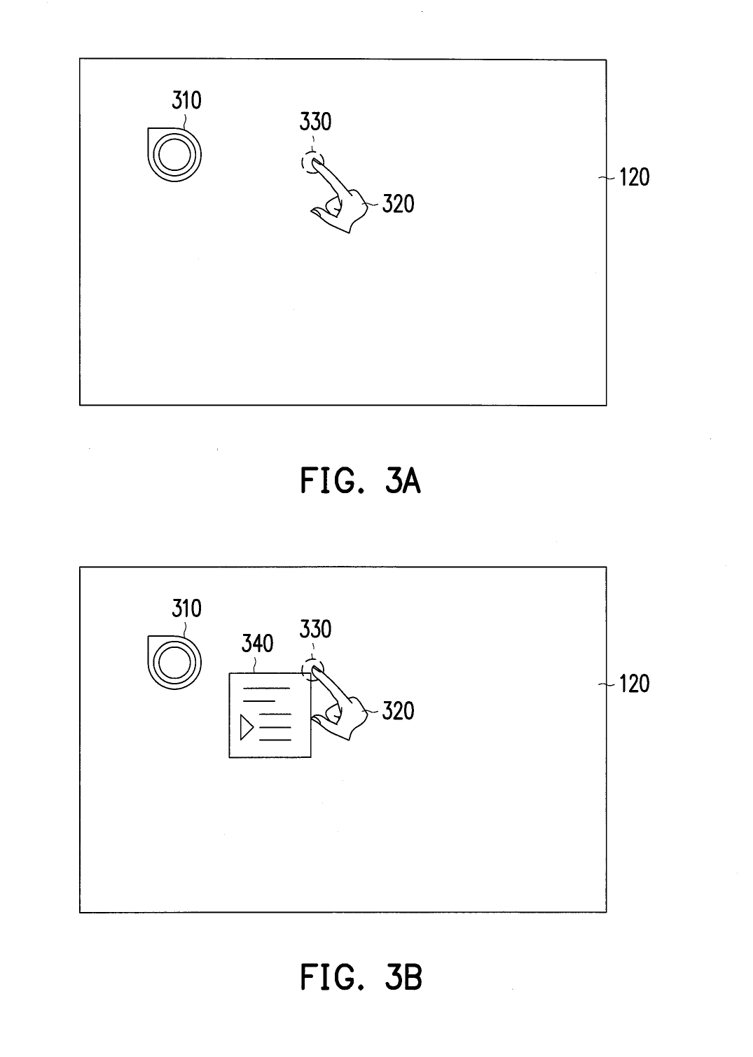

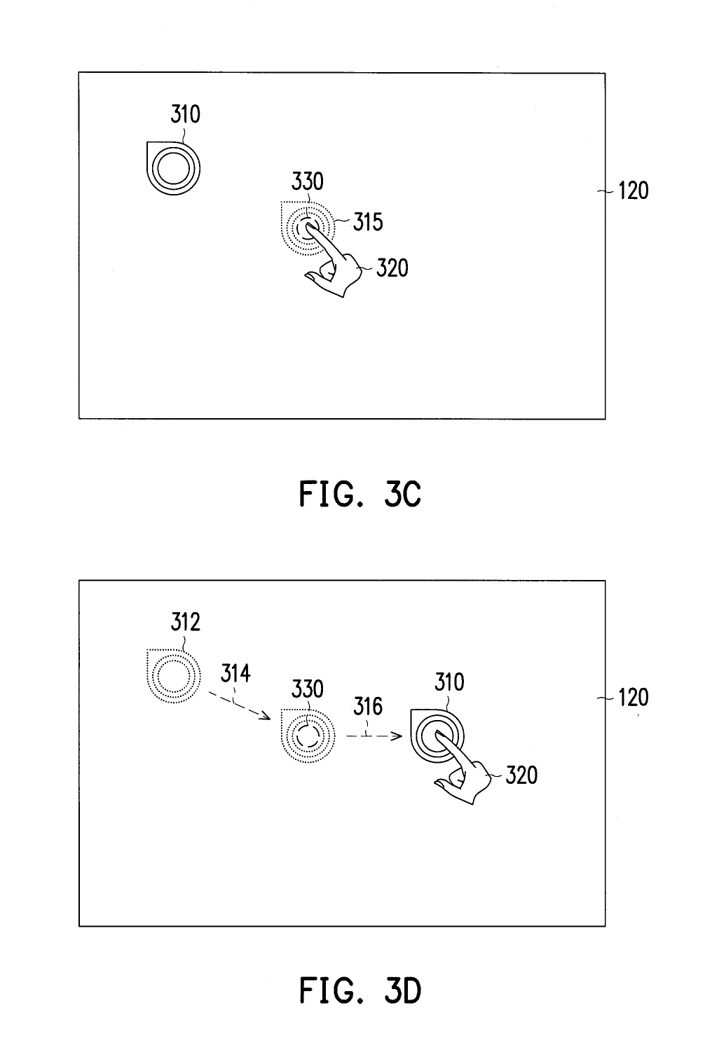

FIG. 2 is a flowchart illustrating a method for operating gestures/method for calling a cursor according to a first embodiment of the invention, FIG. 3A-FIG. 3D are schematic diagrams of a method for calling a cursor according to the first embodiment of the invention. The method for calling a cursor is adapted to the electronic device 100 having the touch area 120 shown in FIG. 1. Referring to FIG. 2 and FIG. 3A, the touch area 120 may have an existing touch cursor 310. In step S210, the electronic device 100 receives a first gesture input to the touch area 120 by the operating object (for example, user's finger 320 shown in FIG. 3A). The first gesture refers to that the finger 320 presses a first position 330 of the touch area 120 by a predetermined time (for example, two seconds). Alternatively, the first gesture may also refer to that the finger 320 touches the first position 330 twice in succession. In the present embodiment, the operating object can also be a stylus, etc., which is not limited to the user's finger.

When the electronic device 100 detects that input of the first gesture is finished, a step S220 is executed, by which the electronic device 100 detects whether the operating object (the finger 320) leaves the touch area 120 from an end point (for example, the first position 330) of the first gesture. When a second gesture is not continuously input by the operating object (the finger 320) from the end point and the operating object (the finger 320) leaves the touch area 120, the electronic device 100 executes a first operation corresponding to the first gesture. Referring to FIG. 3B, in the present embodiment, when the operating object (the finger 320) leaves the touch area 120 after inputting the first gesture, the first operation is executed. The first operation is to display a menu 340 at the end point 330 of the first gesture. Those skilled in the art can also suitably adjust execution content of the first operation, which is not limited by the invention.

In the present embodiment when it is detected that the operating object (the finger 320) does not leave the touch area 120 from the end point of the first gesture (for example, the first position 330), a step S240 is executed, by which the electronic device 100 executes a prompt operation corresponding to a second operation. Referring to FIG. 3C, when the operating object (the finger 320) does not leave the touch area 120 after inputting the first gesture, in order to notify the user a subsequent operation, related prompt information corresponding to the second operation can be displayed. For example, the second operation of the present embodiment is to move the touch cursor 310 to a position where the operating object (the finger 320) contacts the touch area 120, which is described in detail later. Compared to the second operation, the aforementioned prompt operation of the present embodiment is to display a translucent cursor 315 at the end point 330 as shown in FIG. 3C, so as to notify the user to continually input the second gesture (i.e. the finger 302 moves from the end point 330 to the other positions) to execute the second operation.

In step S250, the electronic device 100 detects whether the operating object (the finger 320) continually inputs the second gesture from the end point 330 of the first gesture. If the operating object (the finger 320) does not continually input the second gesture, the flow returns to the step S220 to detect whether the user wants to execute the first operation (i.e. to display the menu 340). Comparatively, if the operating object (the finger 320) continually inputs the second gesture from the end point 330, referring to FIG. 3D, a step S270 is executed, by which the electronic device 100 executes the second operation corresponding to the first gesture and the second gesture. The second operation is that the electronic device 100 calls the touch cursor 310, and moves the touch cursor 310 from the original position 312 to the position where the operating object (the finger 320) contacts the touch area 120, which shown as moving arrows 314 and 316. The moving arrow 314 represents a moving trajectory of the touch cursor 310 when the touch cursor 310 is called, and the moving arrow 316 represents a moving trajectory of the second gesture (a dragging gesture). Moreover, as long as the finger 320 keeps dragging the touch cursor 310, the touch cursor 310 is moved to implement calling of the touch cursor 310. In other words, since the user often uses the first gesture (for example, the press gesture) to display the menu 340, in the present embodiment of the invention, the first gesture is used in collaboration with other gestures (for example, a dragging gesture) to call the touch cursor 310 and move the touch cursor 310, so as to simplify steps for moving the touch cursor to improve convenience for using the touch cursor. On the other hand, the aforementioned gesture method is capable of detecting whether the input gesture is continuous, and executing the corresponding operation according to whether the input gesture is continuous, so as to facilitate providing diversified gesture functions.

On the other hand, “function calling of drawing software” applied to a tablet PC is taken as another example for descriptions. When the electronic device 100 has run certain drawing software, the user's finger can input the first gesture (for example, long-press by the predetermined time) at the touch area. If the finger immediately leaves the touch area after inputting the first gesture, the electronic device 100 executes the first operation corresponding to the first gesture, for example, the electronic device 100 calls an eraser pattern with a predetermined size at an end point of the first gesture. If the finger continually inputs the second gesture after inputting the first gesture, the electronic device 100 calls a specific brush pattern at an end point of the second gesture.

In summary, the method for operating gestures of the invention is capable of detecting whether the input gesture is continuous, and executing the corresponding operation according to whether the input gesture is continuous, so as to facilitate providing diversified gesture functions. On the other hand, according to the method for calling the cursor of the invention, the user can easily use a commonly used gesture combination to call and move the touch cursor, such that steps for moving the touch cursor are simplified to improve convenience for using the touch cursor.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for operating gestures, adapted to an electronic device having a touch area, the method for operating gestures comprising:
receiving a first gesture input to the touch area by an operating object;
detecting a second gesture continuously input by the operating object from an end point of the first gesture after the first gesture is input; and
executing a second operation corresponding to the first gesture and the second gesture.

2. The method for operating gestures as claimed in claim 1, further comprising:
executing a first operation corresponding to the first gesture when the second gesture is not continuously input from the end point and the operating object leaves the touch area.

3. The method for operating gestures as claimed in claim 1, wherein the first gesture refers to that the operating object presses a first position of the touch area by a predetermined time, and the second gesture refers to that the operating object moves from the first position of the touch area to other positions.

4. The method for operating gestures as claimed in claim 3, wherein the first operation is to display a menu.

5. The method for operating gestures as claimed in claim 3, wherein the second operation is to move a touch cursor to a position where the operating object contacts the touch area.

6. The method for operating gestures as claimed in claim 1, further comprising:
executing a prompt operation corresponding to the second operation when the operating object is located at the end point and does not leave the touch area.

7. The method for operating gestures as claimed in claim 6, wherein the prompt operation is to display a translucent cursor at the end point.

8. A method for calling a cursor, adapted to an electronic device having a touch area, the method for calling the cursor comprises:
receiving a first gesture input to the touch area by an operating object;
detecting whether a second gesture continuously input by the operating object from an end point of the first gesture after the first gesture is input; and
calling a cursor and moving the cursor to a position according to the first gesture and the second gesture.

9. The method for calling a cursor as claimed in claim 8, further comprising:
executing an operation corresponding to the first gesture when the second gesture is not continuously input from the end point and the operating object leaves the touch area.

10. The method for calling a cursor as claimed in claim 8, further comprising:
displaying a translucent cursor at the end point when the operating object is located at the end point and does not leave the touch area.

11. The method for calling a cursor as claimed in claim 8, wherein the first gesture refers to that the operating object long-presses a first position of the touch area by a predetermined time, and the second gesture refers to that the operating object moves from the first position of the touch area to other positions.

12. The method for calling a cursor as claimed in claim 8, wherein the first operation is to display a menu.
